(19) United States
(12) Patent Application Publication
(10) Pub. No.: US 2005/0255849 A1
(43) Pub. Date: Nov. 17, 2005

(54) User movement prediction algorithm in wireless network environment

(76) Inventors: Ki B. Kang, San Jose, CA (US); Seong Yong Park, Santa Clara, CA (US)

Correspondence Address: HAVERSTOCK & OWENS LLP, 162 NORTH WOLFE ROAD, SUNNYVALE, CA, 94086, US

(21) Appl. No.: 11/083,623

(22) Filed: Mar. 17, 2005

Related U.S. Application Data
(60) Provisional application No. 60/554,475, filed on Mar. 17, 2004.

(51) Int. Cl. H04Q 7/20

(52) U.S. Cl. 455/446

(57) ABSTRACT

A wireless network including a plurality of cells is configured into groups, each group defining a supercell. Within each supercell, a plurality of boundary cells defines an outer boundary of the supercell. Each boundary cell is adjacent to at least two other supercells. The wireless network also include a plurality of control devices, one control device corresponding to each supercell. Each control device controls communications within the plurality of cells of the corresponding supercell. Each control device utilizes a predictive algorithm to identify the at least two supercells adjacent to a given boundary cell and transmits data packets to a wireless device located in the given boundary cell and to the at least two supercells adjacent to the given boundary cell.

### RELATED APPLICATIONS

This application claims priority of U.S. provisional application, Ser. No. 60/554,475, filed Mar. 17, 2004, and entitled “USER MOVEMENT PREDICTION ALGORITHM IN WLAN ENVIRONMENT”, by the same inventors. This application incorporates U.S. provisional application, Ser. No. 60/554,475 in its entirety by reference.

### FIELD OF THE INVENTION

The present invention relates to wireless networks. In particular, the present invention relates to a method of and apparatus for predicting user movement within a wireless network.

### BACKGROUND OF THE INVENTION

In current wireless cell networks, moving from one cell to another cell involves a hand-off mechanism so that movement of a wireless device from one cell to another cell is seamless. That is, there is no communication disruption to the wireless device. Between two cells, handshaking protocols are exchanged. For example, handshaking authentication protocols are exchanged between a wireless device and an antenna so that the wireless device does not connect with an antenna associated with a different network.

Most wireless cell networks are configured such that cell sizes are sufficiently large so that overlaps exist between adjacent cells. As a wireless device is moved, it will transmit from a region where it can communicate with only a first cell to a region where it can communicate with two or more cells and eventually into a region where it can communicate with only a second cell. As the wireless device moves from the first cell toward the second cell, and enters the overlap area, the second cell is notified to prepare for the possible arrival of the wireless device. In this case, the second cell is said to be in a standby mode.

FIG. 1 illustrates an exemplary conventional wireless cell network in which each cell is sufficiently large as to provide substantially unambiguous overlapping areas between two adjacent cells. As shown in FIG. 1, the exemplary network includes eight cells 1-8, each cell including an antenna 11-18 that provide a coverage area coincident to the corresponding cell. In this exemplary configuration, an overlap exists between cell 1 and cell 2, and between cell 1 and cell 3. Similarly, an overlap exists between cell 2 and cell 4, and between cell 3 and cell 4, and so on. In this conventional case, the coverage area of each cell 1-8 is sufficiently large such that overlap between adjacent cells is substantially limited to overlap between only two different cells. With such a configuration, the wireless network can predict a next cell to which a wireless device can move. As the wireless device moves towards an outer boundary of a first cell, the wireless device will enter a zone in which the first cell overlaps with an adjacent second cell. While the wireless device moves within this overlap area, the wireless system anticipates that the wireless device will move into the second cell, and as such, the second cell prepares to receive the wireless device. Such “preparation” is well known in the art of wireless and cell networks, and includes allocation of resources by the second cell to accommodate a wireless transmission by the wireless device. This is often referred to as placing a cell on standby.

In this case, in some regions of overlap, a wireless device can move only between two cells. In other cases, a wireless device can move to one of four cells. Configurations can exist where a wireless device can move to many cells. These configurations make predicting movement difficult and consume system overhead.

FIG. 2 illustrates movement of a wireless device between cells of the conventional wireless network shown in FIG. 1. In particular, an overlap area A indicates an overlap of cell 1 and cell 2. A wireless device positioned at point 20 within cell 1 moves toward cell 2. As the wireless device nears cell 2, the wireless device enters the overlap area A, such as point 22. Since cell I overlaps only cell 2 in the overlap area A, the wireless network anticipates that the wireless device at point 22 is moving to cell 2, and as such, cell 2 is instructed to prepare for the wireless transmission related to the wireless device. As the wireless device moves from point 22 in the overlap area A to point 24 within cell 2, the wireless transmission related to the wireless device is handed off from cell 1 to cell 2.

Each cell has a specific capacity, that is a maximum number of wireless devices that it can support at any given time. As the number of wireless devices in use continues to increase, the number of cells also increases to handle the increased traffic. Using conventional cell technology with increased cell density makes predicative algorithms difficult to manage. It would be advantageous to be able to use a predictive algorithm in such a multiple-overlapping cell environment.

### BRIEF SUMMARY OF THE INVENTION

Embodiments of the present invention are directed to configuring a wireless network according to supercells, each with a plurality of antennas, and using a predictive algorithm to predict user movement within the supercell network configuration. The wireless network is comprised of a plurality of antennas for each supercell, each antenna providing wireless communications to a defined coverage area. Each antenna and associated coverage area are known as a cell. Groups of cells are placed under the control of a traffic management system. Each group of cells is referred to as a supercell. The traffic management system is implemented within a control device, where each antenna within the supercell is coupled to the control device. The control device manages communications between wireless devices and antennas within a given cell of the supercell. The control device also manages hand-off and preparation procedures between adjacent cells as a wireless device moves from one cell to another cell within the supercell.

Within a given supercell, the plurality of cells that comprise the supercell are configured according to one of two sub-groups. One sub-group of cells is configured to form an outer perimeter of the supercell. Each cell within this first sub-group is referred to as a boundary cell. A second group of cells is configured inside the coverage area formed by the boundary cells. Each cell within this second sub-group is referred to as a center cell, also referred to as a non-boundary cell. Each cell within the supercell preferably partially overlaps with at least one other cell within the supercell.

The wireless network includes any number of adjacently positioned supercells. In one embodiment, a first boundary cell of a first supercell partially overlaps a boundary cell of a second adjacent supercell, and the first boundary cell of the first supercell also partially overlaps a boundary cell of a third adjacent supercell. In an alternative embodiment, the first boundary cell of the first supercell partially overlaps a boundary cell of more than two different adjacent supercells. The architecture of the network can be manually programmed into the various control devices or the system can be deployed and automatically determine its architecture by monitoring wireless device movement.

When the wireless device is located within a boundary cell of a first supercell, the control device associated with the first supercell uses the predictive algorithm to determine which adjacent supercells the wireless device might possible move into. In the case where the first boundary cell overlaps the boundary cell in the second supercell and the first boundary cell also overlaps the boundary cell in the second supercell, then the predictive algorithm determines that the wireless device can possibly move into the second supercell or the third supercell. Once this determination is made, the control device of the first supercell communicates with a control device corresponding with the second supercell and with a control device corresponding to the third supercell. This communication instructs the control devices in the second and third supercells to prepare for the possible arrival of the wireless device, effectively placing the second and third supercells in a standby mode. Once preparations are made and the proper resources are allocated, any data packets currently sent to the wireless device within the first boundary cell of the first supercell are also sent to the control devices of the second and third supercells. The control devices of the second and third supercells then send the received data packets to the appropriate antenna within their respective supercells for transmission of the data packets within the boundary cells of the second and third supercells that overlap with the first boundary cell of the first supercell. In this manner, only those supercells that the wireless device is predicted to possibly move into are placed in standby mode. Since placing a supercell in standby mode requires allocation of resources, system resources are better utilized by minimizing the number of supercells placed in standby mode.

### BRIEF DESCRIPTION OF THE SEVERAL VIEWS OF THE DRAWINGS

FIG. 1 illustrates an exemplary conventional wireless cell network configuration.

FIG. 2 illustrates a movement of a wireless device between cells of the conventional wireless network shown in FIG. 1.

FIG. 3 illustrates an embodiment of a supercell of the present invention.

FIG. 4 illustrates a wireless network configuration according to an embodiment of the present invention.

FIGS. 5 illustrates the movement of a wireless device from one boundary cell to another boundary cell within the same supercell.

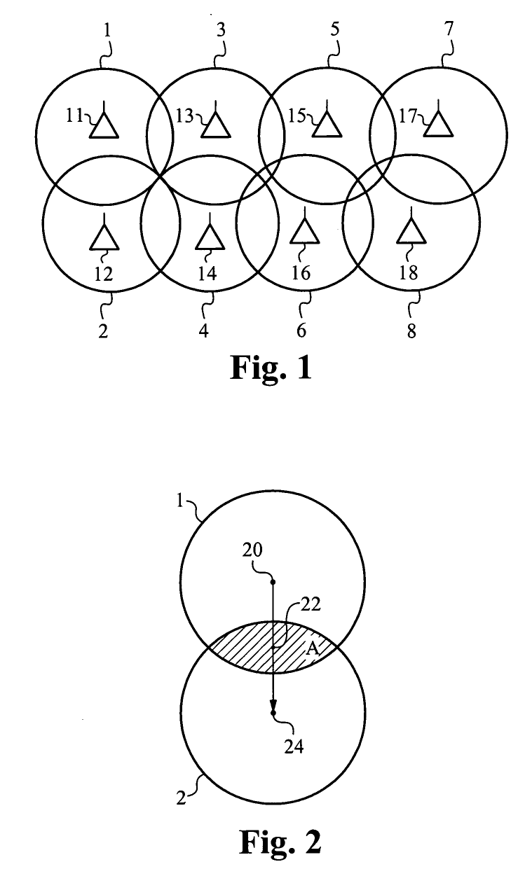

The invention is described relative to the several views of the drawings. Where appropriate and only where identical elements are disclosed and shown in more than one drawing, the same reference numeral will be used to represent such identical elements.

### DETAILED DESCRIPTION OF THE INVENTION

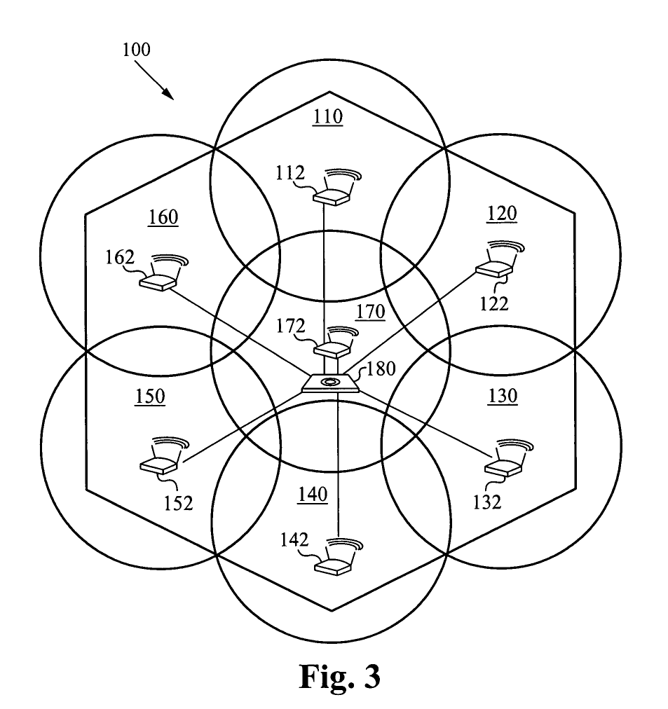

FIG. 3 illustrates a supercell 100 according to an embodiment of the present invention. The supercell 100 preferably comprises 7 individual cells 110, 120, 130, 140, 150, 160, and 170, and each cell 110, 120, 130, 140, 150, 160, and 170 includes an antenna 112, 122, 132, 142, 152, 162, and 172, respectively. Each supercell is preferably configured such that a single cell, referred to as a center cell, is centrally positioned within the supercell. A group of cells, referred to as boundary cells, radially surrounds the center cell to form an outer boundary of the supercell. As shown in FIG. 3, cell 170 is the center cell, and cells 110, 120, 130, 140, 150, and 160 are boundary cells which surround the center cell 170. Each supercell is preferably controlled by a control device. The control device controls communications within the supercell and also utilizes a predictive algorithm for determining into which adjacent supercells the wireless device might possibly move. The antenna from each cell within the supercell is preferably hard-wired to the control device. Alternatively, the control device is coupled to each antenna using any conventional networking means, wired or wireless. In FIG. 3, a control device 180 is wired to the antennas 112, 122, 132, 142, 152, 162, and 172. It is preferable to position the control device at a location that is central to all antennas within the supercell. In a symmetrically configured supercell, such as the supercell 100 of FIG. 3, the control device is most likely positioned in the geometric center of the supercell. However, this is not required to be the case. The control device can be located anywhere within the supercell. Alternatively, the control device is located outside of the conceptual boundary of the supercell.

Although the supercell 100 shown in FIG. 3 includes 7 individual cells, cells 110, 120, 130, 140, 150, 160, and 170, a supercell can include more, or less, than 7 cells. Also, the configuration of the individual cells within a given supercell can vary from supercell to supercell, such that not all supercells in the wireless network are identical in shape or number of antennas. Further, the configuration of the individual cells within a given supercell need not be symmetrical; in fact, the individual cells within a given supercell can be positioned according to any desired or convenient geometrical configuration. Additionally, a supercell need not consist of a single center cell. In general, a supercell can include any number of boundary cells and any number of center, or non-boundary, cells positioned radially inward from the boundary cells.

It is also understood that the coverage area and configuration of each of the cells, as well as the overlap between adjacent cells, as depicted in the figures is for illustrative purposes only. The actual coverage area, configuration, and overlap will vary based on the specifications of each particular wireless network implementation. For example, it is preferred that the individual cells are positioned to minimize, or eliminate, dead zones, while working within economic limitations associated with the wireless network implementation. A dead zone is an area that is not covered by any of the individual cells. Preferably, the wireless network is configured so that there are no dead zones.

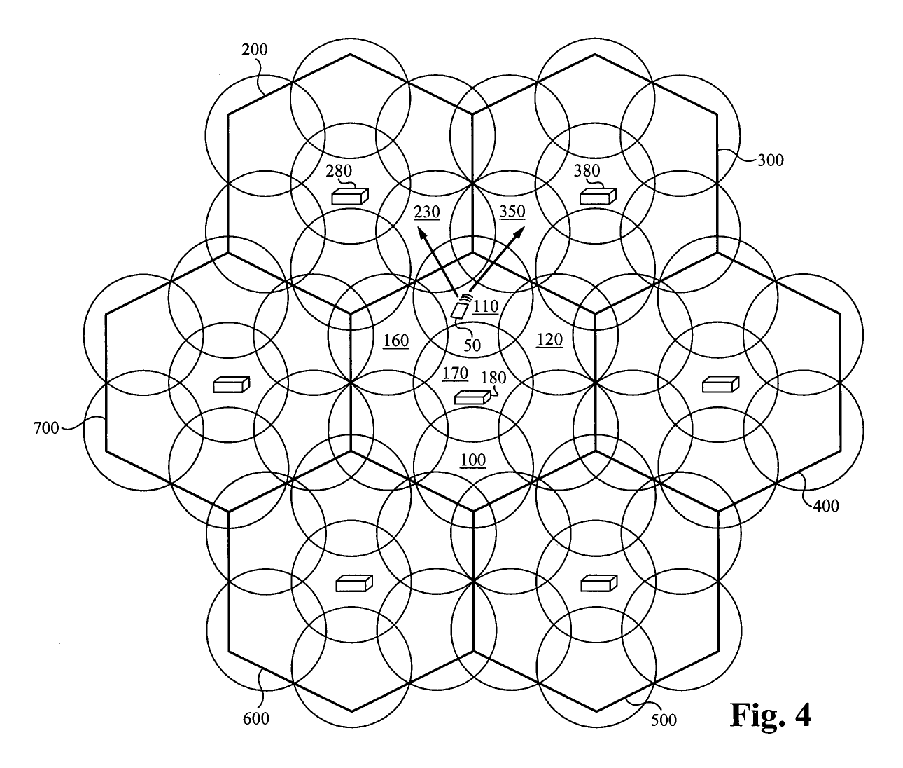

FIG. 4 illustrates a wireless network configuration according to an embodiment of the present invention. The wireless network includes a plurality of adjacently positioned supercells. In FIG. 4, 7 supercells 100, 200, 300, 400, 500, 600, and 700 are shown for illustrative purposes. Each of the supercells 100, 200, 300, 400, 500, 600, and 700 are preferably the same as the supercell 100 illustrated in FIG. 3. Alternatively, each of the supercells can be configured according to any number of various geometric configurations. Each of the supercells 100, 200, 300, 400, 500, 600, and 700 are preferably configured such that while a wireless device is located in a given boundary cell, the wireless device can move to one of two possible adjacent supercells. Each control device utilizes the predictive algorithm to determine which two adjacent supercells the wireless device can possibly move to while currently positioned within a given boundary cell. Once the two possible supercells are determined, the control device within the current supercell sends control communications to the determined two possible supercells to prepare themselves for the possible arrival of the wireless device.

For example, a wireless device 50 is located in cell 110 of supercell 100. While the wireless device 50 is in cell 110, the control device 180 determines that the wireless device 50 can stay where it is, move to the adjacent supercell 200, or move to the adjacent supercell 300. After making this determination, the control device 180 sends a communication to a control device 280 and a control device 380. The control device 280 controls operation of the supercell 200, and the control device 380 controls operation of the supercell 300. In response to receiving the communication from control device 180, the control device 280 places the supercell 200 in a standby mode, which prepares the supercell 200 to receive the wireless device 50. Simultaneously, the control device 380 places the supercell 300 in a standby mode, which prepares the supercell 300 to receive the wireless device 50.

While the wireless device 50 is located within the supercell 100, data packets are sent to the wireless device 50 by an appropriate antenna within the supercell 100. The appropriate antenna is determined as the antenna of the individual cell in which the wireless device 50 is currently located. As shown in FIG. 4, while the wireless device 50 is located within cell 110 of supercell 100, data packets are sent to the wireless device 50 by the antenna 112 (FIG. 3) corresponding to cell 110. Once the supercells 200 and 300 are prepared to receive the wireless device 50, data packets that are sent to the wireless device 50 while in the supercell 100 are also sent to the control device 280 and the control device 380. The control device 280 sends the data packets to the to the antenna corresponding to cell 230 within supercell 200, and the control device 380 sends the data packets to the antenna corresponding to cell 350 within the supercell 300. In this manner, the data packets intended for the wireless device 50 are tri-cast within each of the supercells 100, 200, and 300. Tri-casting is preferably performed according to the method described in the co-owned, co-pending provisional application, Ser. No. ______, filed on Jan. 27, 2005, entitled “IP TRI-CAST MECHANISM FOR LOW LATENCY AND LOW DATA LOSS HANDOVER IN WIRELESS NETWORK”, which is hereby incorporated by reference. In this manner, a complete duplicate of the data packets are sent to each of the three supercells, the one supercell in which the wireless device is currently located and the two possible adjacent supercells.

When a wireless device is located in a first cell of a first supercell, the control device associated with the first supercell prepares for possible movement of the wireless device to all cells within the first supercell 100 that are adjacent to the first cell. For example, as applied to FIG. 4, when the wireless device 50 is located in cell 110, the control device 180 prepares for possible movement of the wireless device 50 to the adjacent cells 120, 160, and 170.

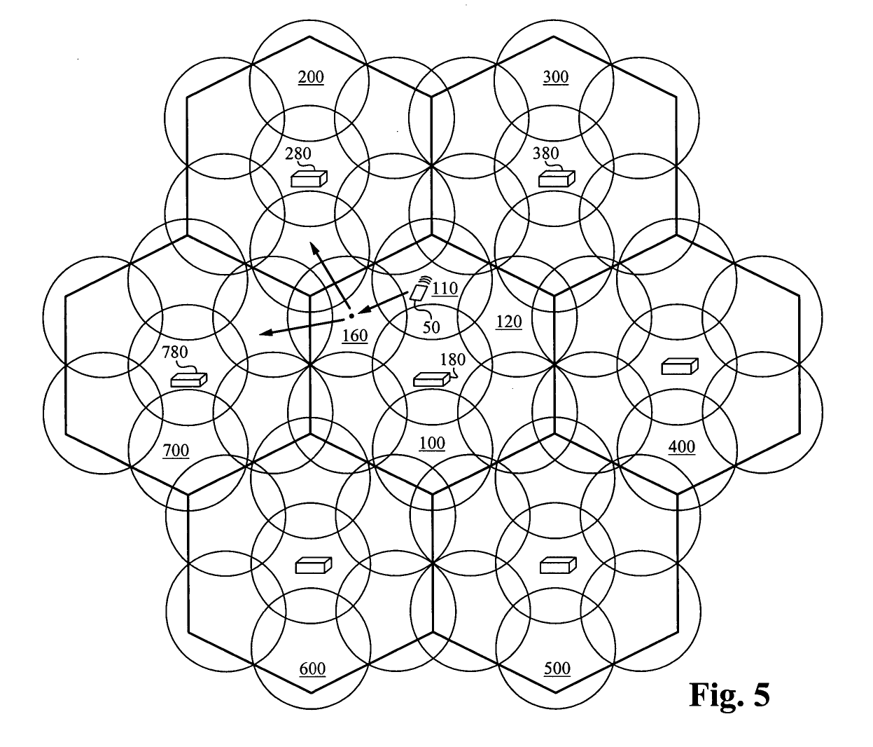

If the wireless device does not move to an adjacent supercell, but instead moves to a second boundary cell within the same supercell, then the control device associated with the supercell again determines to which two adjacent supercells the wireless device can possibly move from the second boundary cell. FIGS. 5 illustrates the movement of a wireless device from one boundary cell to another boundary cell within the same supercell. For example, movement of the wireless device 50 from cell 110 to cell 160 occurs within the same supercell 100. When wireless device 50 is located within cell 110, supercells 200 and 300 are in standby mode, as described above in relation to FIG. 4. As wireless device 50 moves from cell 110 to cell 160, the communication link provided by the antenna 112 (FIG. 3) in cell 110 is handed off to the antenna 162 (FIG. 3) in cell 160 under the control of the control device 180. Once the wireless device 50 is located within the cell 160, the control device 180 utilizes the predictive algorithm to determine which two adjacent supercells the wireless device 50 can possibly move to while positioned within the boundary cell 160. In this case, it is determined that the wireless device 50 can possibly move to the adjacent supercell 200 or to the adjacent supercell 700.

When the wireless device 50 was located in cell 110, the supercell 300 was in standby mode. With the movement of the wireless device 50 to cell 160, supercell 300 is no longer required to remain in standby mode. As such, the control device 180 sends a communication to the control device 380 to cancel its preparation for possible arrival of the wireless device 50, effectively taking supercell 300 off standby mode. The control device 180 also sends a communication to a control device 780. The control device 780 controls operation of the supercell 700. The communication from control device 180 notifies the control device 780 to place the supercell 700 in a standby mode, which prepares the supercell 700 to receive the wireless device 50. Since the supercell 200 was already in standby mode, no additional communication is sent by the control device 180 to the control device 280, and the supercell 200 remains in standby mode.

If the wireless device 50 moves from a boundary cell, such as cell 110, to a center cell, such as cell 170, then the control device 180 determines that the wireless device 50 is no longer located in a boundary cell. As such, it is not possible that the wireless device 50 moves directly from the center cell 100 to another supercell, such as one of the supercells 110, 120, 130, 140, 150, 160, and 170. Therefore, it is not necessary that any of the supercells 110, 120, 130, 140, 150, 160, and 170 are maintained in the standby mode. When the wireless device 50 is located in the cell 110, supercells 200 and 300 are in standby mode. As the wireless device 50 moves from the boundary cell 110 to the center cell 170, the control device 180 sends a communication to each of the control devices 280 and 380 to cancel preparation for possible arrival of wireless device 50, effectively taking supercells 200 and 300 off standby mode. While the wireless device 50 is located within the center cell 170, none of the supercells 110, 120, 130, 140, 150, 160, and 170 that are adjacent to supercell 100 are in standby mode.

From the point of view of the wireless device, communications between the wireless device and any antenna use the same protocols, regardless of which supercell the antenna is associated. Whether the wireless device is moving from cell to cell within the same supercell, or the wireless device is moving from a cell in one supercell to a cell in another supercell, the protocol used between the wireless device and the antennas is the same. However, from the point of view of the control devices, there is a difference between whether the wireless device is moving from cell to cell within the same supercell, or from a cell within a first supercell to another cell within a second supercell. Where the wireless device moves between cells within the same supercell, the same control device maintains operation of the communications. However, where the wireless device moves from supercell to supercell, a hand-off occurs between the control devices of the associated supercells. In one embodiment, the wireless device and the antenna communicate according to the bottom two layers, layer 1 and layer 2, of the OSI model, and the control device communicates to the antennas or to other control devices according to the upper layers, layers 3 and above, of the OSI model. In another embodiment, the wireless device and the antenna only communicate according to the first layer, and the control device communicates according to layer 2 and above.

The wireless network configuration described above in relation to FIGS. 4 and 5 describes an embodiment in which each boundary cell is associated with two adjacent supercells to which a wireless device might possibly move. In other embodiments, each boundary cell can be associated with more than two possible adjacent supercells. For each possible adjacent supercell that a wireless device might roam to, a copy of the data packets currently being sent to the wireless device is also sent. For example, where a wireless device is currently located in a boundary cell that is associated with three possible adjacent supercells, a complete data packet is sent to each of the three possible adjacent supercells.

In the embodiments described above, one control device is used to control one supercell. In an alternative embodiment, one control device can be used to control multiple supercells.

The supercell configuration of the present invention can be applied to any type of wireless network including, but not limited to, a wireless local area network (WLAN), a wireless metro area network (WMAN), and a wireless wide area network (WWAN).

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made to the embodiments chosen for illustration without departing from the spirit and scope of the invention.

1. A wireless network comprising:
a. a plurality of antennas, wherein a coverage area of each antenna defines a cell, thereby forming a plurality of cells, wherein the plurality of cells are configured in groups, each group defining a supercell, further wherein each group of cells includes a plurality of boundary cells that define an outer boundary of the supercell, wherein each boundary cell is adjacent to at least two other supercells; and
b. at least one control device coupled to provide control signals to the plurality of antennas such that while a wireless device is located within a first boundary cell of a first supercell each of the at least two adjacent supercells are configured in a standby mode, whereby data packets provided to the wireless device within the first boundary cell are also provided to the at least two adjacent supercells.

2. The wireless network of claim 1 wherein the wireless network comprises a wireless local area network.

3. The wireless network of claim 1 wherein the wireless network comprises a wireless metro area network.

4. The wireless network of claim 1 wherein the wireless network comprises a wireless wide area network.

5. The wireless network of claim 1 wherein each supercell is controlled by a dedicated control device.

6. The wireless network of claim 5 wherein a first control device dedicated to a first supercell is coupled to each antenna within the first supercell.

7. The wireless network of claim 6 wherein the first control device is coupled to each antenna via a wired connection.

8. The wireless network of claim 6 wherein the first control device is coupled to each antenna via a wireless connection.

9. The wireless network of claim 1 wherein a coverage area of each supercell comprises an arbitrary geometric configuration.

10. The wireless network of claim 1 wherein the at least one control device includes a predictive algorithm to identify the at least two supercells adjacent to each boundary cell.

11. The wireless network of claim 1 wherein a portion of each cell overlaps a portion of at least one other cell.

12. The wireless network of claim 1 wherein a portion of each boundary cell overlaps a portion of the at least two adjacent supercells.

13. The wireless network of claim 1 wherein one control device controls a plurality of supercells.

14. A wireless network comprising:
a. a plurality of cells, each cell including an antenna, wherein the plurality of cells are configured in groups, each group defining a supercell, further wherein each group of cells includes a plurality of boundary cells that define an outer boundary of the supercell, wherein each boundary cell is adjacent to at least two other supercells; and
b. a plurality of control devices, one control device corresponding to each supercell, wherein each control device controls communications within the plurality of cells of the corresponding supercell, further wherein each control device utilizes a predictive algorithm to identify the at least two supercells adjacent to a given boundary cell and transmits data packets to a wireless device located in the given boundary cell and to the at least two supercells adjacent to the given boundary cell.

15. The wireless network of claim 14 wherein the wireless network comprises a wireless local area network.

16. The wireless network of claim 14 wherein the wireless network comprises a wireless metro area network.

17. The wireless network of claim 14 wherein the wireless network comprises a wireless wide area network.

18. The wireless network of claim 14 wherein a first control device corresponding to a first supercell is coupled to each antenna within the first supercell via a wired connection.

19. The wireless network of claim 14 wherein a first control device corresponding to a first supercell is coupled to each antenna within the first supercell via a wireless connection.

20. The wireless network of claim 14 wherein a coverage area of each supercell comprises an arbitrary geometric configuration.

21. The wireless network of claim 14 wherein a portion of each cell overlaps a portion of at least one other cell.

22. The wireless network of claim 14 wherein a portion of each boundary cell overlaps a portion of the at least two adjacent supercells.

23. A method of configuring a wireless network, the method comprising:
a. configuring a plurality of cells, each cell including an antenna;
b. configuring the plurality of cells into groups, each group of cells defining a supercell, wherein each supercell includes a plurality of boundary cells that define an outer boundary of the supercell;
c. configuring each boundary cell to be adjacent to at least two other supercells;
d. controlling communications within each supercell using a control device;
e. utilizing a predictive algorithm to identify the at least two supercells adjacent to a given boundary cell; and
f. transmitting data packets to a wireless device located in the given boundary cell and to the at least two supercells adjacent to the given boundary cell.

24. The method of claim 23 further comprising notifying the at least two supercells identified by the predictive algorithm to allocate resources for the transmitted data packets.

25. The method of claim 24 further comprising placing the at least two supercells into a standby mode in response to the at least two supercells receiving the notification.

26. The method of claim 23 wherein configuring the plurality of cells comprises overlapping a portion of each cell with a portion of at least one other cell.

27. The method of claim 23 wherein configuring the plurality of cells into groups comprises overlapping a portion of each boundary cell with a portion of the at least two adjacent supercells.

28. The method of claim 23 wherein configuring the plurality of cells into groups comprises configuring each supercell according to an arbitrary geometric configuration.

29. The method of claim 23 further comprising utilizing the predictive algorithm to identify at least two supercells adjacent to a second boundary cell when the wireless device moves from the given boundary cell to the second boundary cell.
